(19) United States
(12) Patent Application Publication
(10) Pub. No.: US 2008/0133499 A1
(43) Pub. Date: Jun. 5, 2008

(54) SYSTEMS AND METHODS FOR PROVIDING CONTACT INFORMATION OF SEARCHED JOBSEEKERS

(75) Inventors: ADAM HYDER, LOS ALTOS, CA (US); GEOFFREY VINCENT PEREZ, SAN JOSE, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/567,165

(22) Filed: Dec. 5, 2006

(51) Int. Cl. G06F 17/30

(52) U.S. Cl. 707/5; 707/E17.108

(57) ABSTRACT

Methods and systems of providing contact information to recruiters are disclosed. A search request can be received from a recruiter. The search can include search criteria. A set of jobseekers having associated metadata that match the search criteria is identified. A recruiter can provide an indication that the recruiter is interested in a jobseeker from the set of jobseekers. The recruiter can be provided with the ability to purchase contact information of the jobseeker for a base price.

### BACKGROUND

1. Field

The present disclosure relates to job listing services. In particular, it relates to systems and methods of providing jobseeker information to a recruiter.

2. General Background

Job listing providers generally provide searchable databanks of job listings related to employment opportunities and openings. In the current generation of online job listing services, listing service providers provide job searching capabilities to jobseekers based on search keywords entered by the jobseeker. In addition, listing service providers allows recruiters to receive previously submitted resumes of jobseekers. Conventional systems require a recruiter to have a subscription, and pay a monthly premium for such subscription, in order to receive resumes with contact information. As such, small companies generally have to pay subscription fees, which are usually large premiums, even if they only want to contact one or two jobseekers.

### SUMMARY

In one aspect, there is a method of providing contact information to recruiters. A search request can be received from a recruiter. The search can include search criteria. A set of jobseekers having associated metadata that match the search criteria is identified. A recruiter can provide an indication that the recruiter is interested in a jobseeker from the set of jobseekers. The recruiter can be provided with the ability to purchase contact information of the jobseeker for a base price.

In another aspect, the recruiter can be permitted to view a resume of the jobseeker before purchasing the contact information of the jobseeker.

In another aspect, it is determined if qualifications of the jobseeker are relevant to the job. The recruiter can be charged an additional fee if the qualifications of the jobseeker are determined to be more relevant.

In yet another aspect, contact information of a plurality of jobseekers can be provided to the recruiter in bulk such that the recruiter can receive a discounted price when purchasing contact information for multiple jobseekers.

In a further aspect, the recruiter can pay no subscription fee in addition to the base fee. Alternatively or in addition, the recruiter can be charged a reduced subscription fee in addition to the base fee.

In one aspect, there is a system to provide jobseeker contact information to a recruiter. The system can include a search engine, a user interface module, and an accounting module. The search engine can search a jobseeker database to identify a set of jobseekers having associated metadata that match a search criteria received from the recruiter. The search criteria can be received as part of a jobseeker search request. The user interface module communicates with a recruiter computing device and with a jobseeker computing device. The user interface module can be configured to receive the jobseeker search request. The user interface module can be further configured to receive an indication from the recruiter that the recruiter is interested in a jobseeker from the set of jobseekers. The user interface module can be further configured to permit the recruiter to purchase contact information of the jobseeker. The accounting module can charges a base price to the recruiter if the recruiter purchases the contact information of the jobseeker.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing contact information to a recruiter according to one embodiment.

FIG. 2 depicts a component diagram of a computing device according to one embodiment.

FIG. 3 depicts an exemplary user interface for uploading a resume according to one embodiment.

FIG. 4 depicts an exemplary user interface for posting a job listing according to one embodiment.

FIG. 5 depicts a flow diagram of a process for providing a recruiter with contact information of a jobseeker who has applied for a job listing posted by the recruiter according to one embodiment.

FIG. 6 depicts an exemplary user interface for listing jobseekers that have applied for a job listing posted by the recruiter according to one embodiment.

FIG. 7 depicts a flow diagram of a processor for permitting a recruiter to search for jobseekers and obtain contact information for one or more jobseekers according to one embodiment.

FIG. 8 depicts an exemplary user interface for permitting a recruiter to enter and submit a search for jobseekers according to one embodiment.

FIG. 9 depicts an exemplary user interface for listing jobseekers that result from a search for jobseekers by a recruiter according to one embodiment.

FIG. 10 depicts a flow diagram of a process for providing a recruiter with contact information of one or more recommended jobseekers according to one embodiment.

FIG. 11 depicts an exemplary user interface that lists recommended jobseekers according to one embodiment.

### DETAILED DESCRIPTION

The system and method disclosed herein permits a recruiter to view jobseeker qualifications and purchase contact information of a jobseeker in which the recruiter is interested. The recruiter can be presented with the jobseekers resume without the contact information of the jobseeker. Once the recruiter inspects the resume, the recruiter can purchase the contact information of individual jobseekers for a base price without having to pay a membership or subscription fee.

The recruiter receives listings of jobseekers in multiple ways. In one embodiment, the recruiter receives resumes of jobseekers who have applied for a job posted by the recruiter. In addition, automatic relevance checking can be performed on resumes that jobseekers have submitted as part of an application. The relevance checking can indicate to a recruiter whether the applying jobseeker is a good candidate. In another embodiment, the recruiter searches for resumes based on search criteria. In yet another embodiment, the recruiter can receive recommendations of jobseekers that have qualifications that match the requisites of jobs posted by the recruiter.

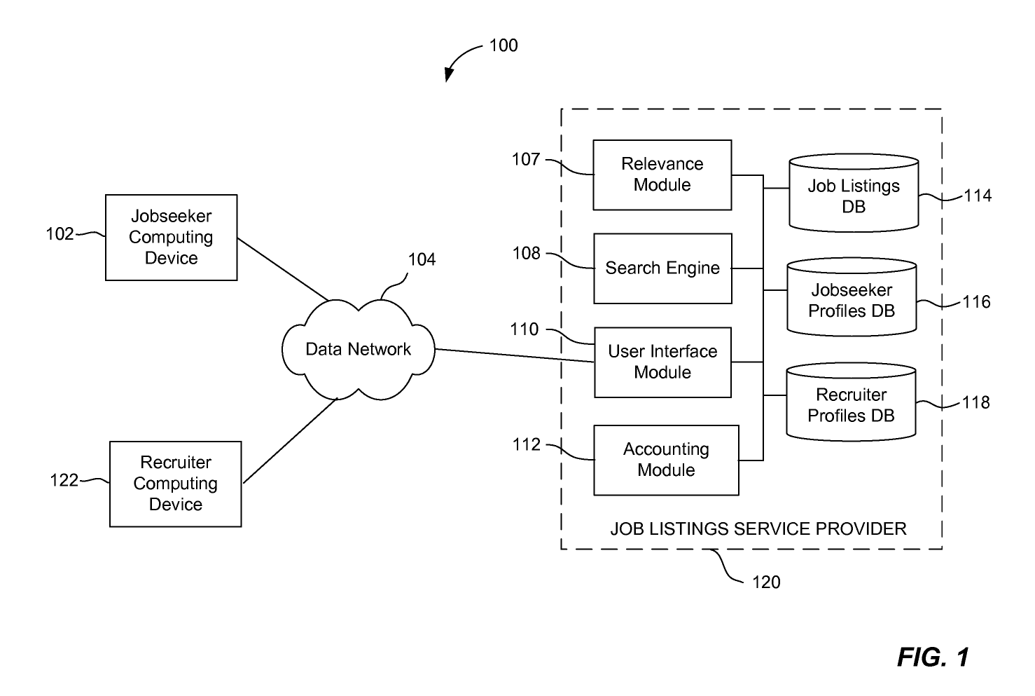

FIG. 1 depicts a component diagram of a system for providing contact information to a recruiter according to one embodiment. In one embodiment, the job listing service provider 120 can host an online service of listing, posting and searching jobs. As such the job listing service provider 120 can be a business entity that owns and operates a computer infrastructure connected to a data network in order to provide a job listing service.

Jobseekers can access the services provided by the job listing service provider 120 via a data network 104. In one embodiment, the data network 104 is the Internet. In another embodiment, the data network 104 is an intranet. A jobseeker can utilize a jobseeker computing device 102 to communicate via the data network 104 with one or more computing modules and or services that are part of the computer infrastructure managed by the job listing service provider 120. In addition, a recruiter can utilize a recruiter computing device 122 to communicate via the data network 104 with one or more computing modules and or services that are part of the computer infrastructure managed by the job listing service provider 120.

In one embodiment, a user interface module 110 can be included as part of the computer infrastructure operated by the listing service provider 120. The user interface module 110 can be configured with logic to communicate with the jobseeker computing device 102 by sending and receiving data. Likewise, the user interface module 110 can be configured with logic to communicate with the recruiter computing device 122 by sending and receiving data.

In addition, in one embodiment, the user interface module 110 is configured to receive job search requests from the jobseeker computing device 102. The job search requests can include parameters entered by the jobseeker such as location, title, and salary of a job listing. In another embodiment, the user interface module 110 can be configured to receive an indication from the jobseeker that the jobseeker is interested in a job from the set of job listings. For example, the indication can be the submission of a resume by the jobseeker, the submission of personal data, checking a checkbox in a user interface that indicates that the user would like to apply for a particular job listing, etc.

In another embodiment, the user interface module 110 can be configured to receive a jobseeker search request from a recruiter. The jobseeker search request can be submitted by a recruiter to search for one or more jobseekers that match the criteria established by the recruiter.

In another embodiment, the user interface module 110 can be further configured to receive an indication from the recruiter that the recruiter is interested in a jobseeker. The indication can be for example a request to download or otherwise obtain the contact information of a jobseeker. In another example, the indication can be the checking of a checkbox that corresponds to a jobseeker.

In another embodiment, the user interface module 110 can be further configured to permit the recruiter to purchase the contact information of the jobseeker. The contact information provided can be obtained from the resume that the jobseeker has submitted.

In one embodiment, the user interface module 110 can be configured to receive the set of jobseeker qualifications. For example, qualifications associated with a jobseeker can include positions held, years of experience, computer skills, activities performed at previous jobs, etc. In another embodiment, the user interface module 110 can be further configured to receive the set of requisites of the job listing. For example, the set of requisites can include minimum years of experience, expected certifications, activities performed at previous jobs, etc.

In another embodiment, the user interface module 110 can be configured with logic to strip or hide the contact information of the jobseeker in the resume such that resumes published to recruiters do not have the contact information of the jobseeker.

In one embodiment, a search engine 108 can be included as part of the computer infrastructure operated by the listing service provider 120. The search engine 108 can communicate with a job listings database 114 to store and retrieve job listing data.

Furthermore, the search engine 108 can also communicate with a jobseeker profiles database 116 to store and retrieve jobseeker's profiles. For example, jobseeker qualifications, jobseeker resume, personal data, contact information, etc., can be stored at the jobseeker profiles database 116.

In addition, the search engine 108 can also communicate with a recruiter profiles database 118 to store and retrieve a recruiter's profiles data. For example, the set of requisites can include listed jobs, requisites for listed jobs, contact information, company data and information, etc.

In one embodiment, searches by a jobseeker can be received at the search engine 108. Jobseeker queries can be received at a search engine 108. In one embodiment, the search engine 108 is configured with logic to determine whether the search words submitted by the jobseeker match any job listing descriptions as stored in the job listings database 106. For example, job listings can have metadata such as job title, location, surrounding areas, salary, associated keywords, employer name, identifiers, job affinity information, etc. The search engine 108 can be configured to compare each of these pieces of data against search words used by the jobseeker.

Thus, the search engine 108 is configured to search a job listing database 114 to identify a set of job listings having associated metadata that match the search criteria received from the jobseeker.

In another embodiment, searches by a recruiter can be received at the search engine 108. The search engine 108 can be configured to search the jobseeker profiles database 116 to identify a set of jobseekers having associated metadata that match a search criteria received from the recruiter.

Furthermore, the search engine 108 can interact with a relevance module 107 to further refine search results. In one example, the jobseeker search is refined to show more relevant jobs based on the profile of the jobseeker. In another example, the recruiter search is refined to show more relevant applicants based on requisites of the recruiter.

In another example, the search engine 108 can interact with the relevance module 107 in order to perform matching of job listing requisites and jobseeker qualifications in order to provide the recruiter with a list of relevant jobseekers. The recruiter can then download or obtain the contact information of the relevant jobseeker for a price.

In order to extract jobseekers that fit the requisites for a job listing, the relevance module 107 can utilize jobseeker qualifications and preferences, as well as job listing requisites and/or recruiter data. In one embodiment, the relevance module 107 can be configured to retrieve qualifications and preference data from the jobseeker profiles database 114. Preference data in the jobseeker profile can be either implicit or explicit. In another embodiment, the relevance module 107 can be configured to obtain a cookie or other stored information in the computing device 102. In yet another embodiment, the relevance module 107 can be configured to query any other data repository that stores data associated with jobseeker preference. Once the data related to jobseeker preferences is collected, the collected data can be stored in association to the jobseeker. In one embodiment, jobseeker preferences can be stored in a jobseeker's profile in the jobseeker profiles database 116. In another embodiment, jobseekers' preferences can be stored in a jobseeker computing device 102. For example, the jobseeker's preferences can be stored in the form of one or more cookies.

In a further embodiment, in order to obtain job listings that fit the qualifications of a jobseeker, the relevance module 107 can retrieve data associated with job listings stored in the job listings database 114.

Once the qualifications of a jobseeker and the requisites of a job listing are matched, the best matches (performed using known methods of matching) can be provided to the recruiter as a list of recommended jobseekers. The recruiter can then select to purchase the contact information of one or more of the recommended jobseekers.

In one embodiment, an accounting module 112 can be included as part of the computer infrastructure operated by the listing service provider 120. The accounting module can be configured to communicate with a recruiter profiles database 118 to store and retrieve the recruiter's profiles data, payment history, billing, etc.

In one embodiment, the accounting module 112 can provide a multi-tiered pricing schedule for providing contact information to a recruiter. In one example, the accounting module 112 can be configured to charge the recruiter a base price if the recruiter purchases contact information of a jobseeker.

In another example, the accounting module 112 can be configured to charge the recruiter a premium price if the recruiter purchases contact information of a jobseeker that has been determined by the relevance module 107 to match with a job listing of the recruiter.

In another example, the accounting module 112 can be configured to charge the recruiter a discount package price for a predetermined number of resumes and the associated contact information. For instance, the recruiter may be charged fifteen dollars for ten resumes with contact information, and twenty five dollars for twenty resumes with contact information.

In yet another example, the accounting module 112 can charge the recruiter a base amount in addition to a pre-established charge per resume with contact information.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

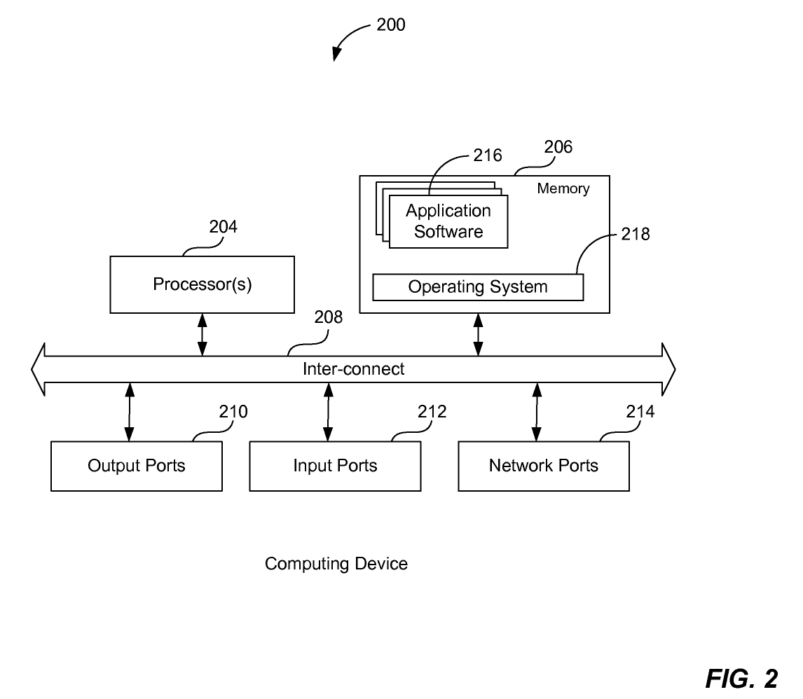

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, and receive and transmit digital signals, as required by the jobseeker computing device 102. In another example, the computing device 200 can be utilized to process calculations, execute instructions, receive and transmit digital signals, and receive and transmit search queries, job listings, and hypertext, as required by the relevance module 107, the search engine 108, the user interface module 110 and the accounting module 112.

The computing device 200 can be any general or special purpose computer now known or to become known capable of performing the steps and/or performing the functions described herein, either in software, hardware, firmware, or a combination thereof.

The computing device 200 includes an interconnect 208 (e.g., bus and system core logic), which interconnects microprocessor(s) 204 and memory 206. The interconnect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output ports 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The interconnect 208 can also include a network connection 214.

The memory 206 may include ROM (Read Only Memory), and volatile RAM (Random Access Memory) and non-volatile memory, such as a hard drive, flash memory, etc. Volatile RAM is typically implemented as dynamic RAM (DRAM), which requires continuous power in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, and optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

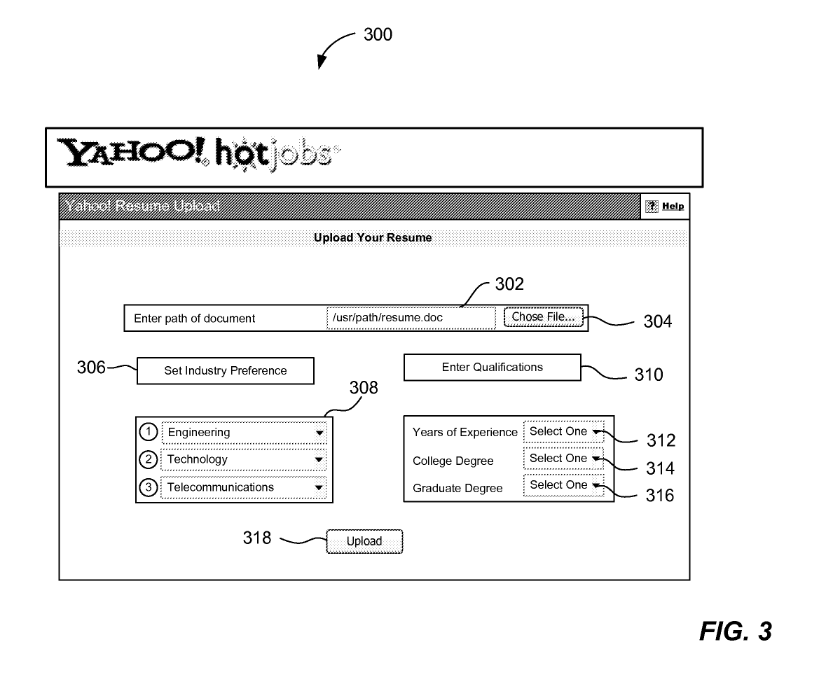

FIG. 3 depicts an exemplary user interface 300 for uploading a resume according to one embodiment. A jobseeker can upload his or her resume through a website of the job listing service provider 120. A jobseeker can enter the file path of the location of a digital document that corresponds to the jobseeker's resume in a text field 302. In one example, the jobseeker can choose the file path by selecting a button 304 to browse the contents of one or more data storage devices associated with the jobseeker computing device 102.

Once the file path of the resume is entered by the jobseeker, the jobseeker can explicitly indicate jobseeker's preferences and/or qualifications. For example, the jobseeker can enter an industry preference using one or more dropdown menus 308. The jobseeker can indicate that the first preference for an industry that the jobseeker would like to work in is “Engineering.” As a second level preference the jobseeker can select “Technology.” In addition, the jobseeker can select “Telecommunications” as the third industry of preference. In one example, these preferred industries can be saved as part of the jobseeker profile. In another example, these preferred industries can be saved on the jobseeker computing device 102.

In one embodiment, jobseeker explicit selections utilizing for example weights or scores that would indicate the jobseeker preferences for these industries and the corresponding scores. As such, when the jobseeker later searches for job listings, the relevance module 107 can utilize the industry scores to further refine the job listing that would be more appropriate and relevant to the jobseeker.

In another example, the jobseeker can enter qualifications. For example, the jobseeker can enter the years of experience of the jobseeker in a drop down box 312. In another example, the jobseeker can enter the bachelor's degree received by the jobseeker in a drop down box 314. In another example, the jobseeker can enter the graduate degree received by the jobseeker in a drop down box 316.

Upon receiving a command to upload the resume, and the entered preferences and qualifications, the search engine 108 can be configured to parse the text in the resume. The text in the resume can further be utilized by the search engine 108 and the relevance module 107 in order to establish implicit preferences and qualifications of the jobseeker. As such, the search engine 108 can identify words or areas of interest based on the submitted resume of the jobseeker. Therefore, specific skills, industries, locations, prior employers, education, etc., can be identified in relation to a jobseeker. For example, the search engine 108 can be configured to recognize text that corresponds to a geographical location such as cities and states that are included in the resume. In addition, the search engine 108 can be configured to provide a higher weight to those geographical locations that appear with higher frequency in the jobseeker's resume. Then, based on the frequency of appearance in the resume, geographical locations can be implicitly included in the jobseeker's profile as being preferences of the jobseeker. As mentioned before, such preferences can later be used for refining and providing a more relevant search result when a jobseeker submits a job search.

In addition, other user interfaces can also be provided to the jobseeker such that the jobseeker can enter explicit preferences and/or qualifications later utilized to further refine a job search submitted by a jobseeker.

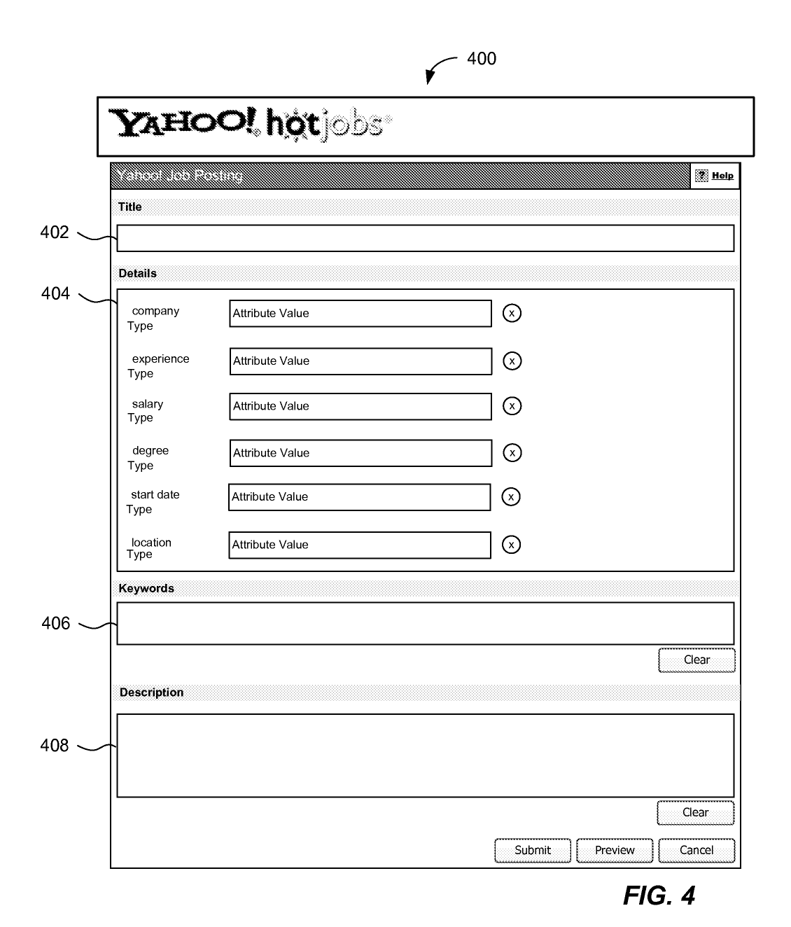

FIG. 4 depicts an exemplary user interface for posting a job listing according to one embodiment. The user interface 400 can be provided by the job listing service provider 120. A recruiter such as an employer can enter a new job listing in the user interface 400 which can later be displayed at the website of the job listing service provider 120. A title field 402 can be provided to enter a title or designation for the job listing. Attribute fields 404 can be provided for entering further information regarding the listing being entered. For example, for a job listing, attributes that can be entered in the attribute fields 404 include company, experience, salary, degree, start date, location, etc. In addition, a keyword field 408 and a description field 410 can also be provided to the recruiter in order to further qualify and/or describe the listed job.

### Jobseeker Applies

Recruiters can be provided with contact information of jobseekers that have expressed interest in a job listing that a recruiter has posted. In general, jobseekers can express an interest in a job listing of a recruiter by submitting an application or the resume of the jobseeker for consideration by the recruiter. Each jobseeker can search for job listings through the jobseeker computing device 102 which submits a query to the job listing service provider 120 and is processed at the search engine 108. If the jobseeker finds a job listing that a jobseeker is interested in a jobseeker can submit an indication of interest which is then recorded in a job listing stored at the job listing database 114. Alternatively, the indication of interest can be, for example, stored at the recruiter profile in the recruiter profile database 118.

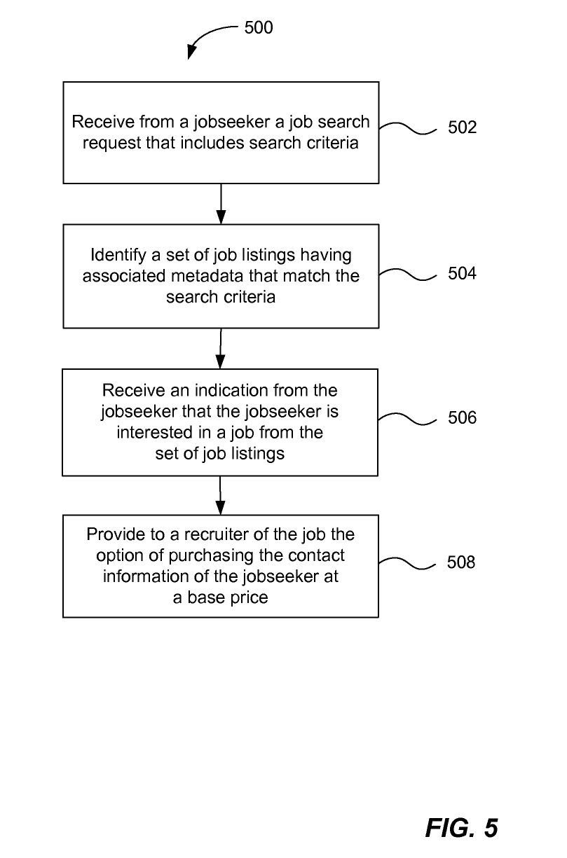

FIG. 5 depicts a flow diagram of a process 500 for providing a recruiter with contact information of a jobseeker who has applied for a job listing posted by the recruiter according to one embodiment. At process block 502, a job search request is received from a jobseeker and processed by the search engine 108. The search request can include search criteria to find job listings that meet the requisites of the jobseeker. Process 500 continues at process block 504.

At process block 504, a set of job listings having associated metadata that matches the search criteria is identified. The associated metadata of each of the job listings in the set of job listings can be a selected location, salary, job title, etc. As previously mentioned, the associated metadata can be stored with, or as part of, each job listing that is stored in the job listing database 114. The search engine 108 can then be configured to match the metadata of the job listings and the job listing database 114 with the search criteria listed by the jobseeker. Process 500 continues at process block 506.

At process block 506 an indication from the jobseeker is received indicating that the jobseeker is interested in a job from the set of job listings. As mentioned above, the indication of interest from the jobseeker can be for example the submission of the jobseeker's resume for a specific job posting. In this case, the jobseeker would submit the resume for the job in the set of job listings. Process 500 continues at process block 508.

At process block 508, the recruiter of the job in which the jobseeker is interested is provided with the option to purchase the contact information related to the jobseeker for a price. Because the jobseeker's resume that is presented to the recruiter does not display jobseeker contact information, the recruiter has an incentive to pay for the contact information of the jobseeker if the recruiter wants to contact the jobseeker for an interview. As such, the recruiter can view all of the qualifications of the applying jobseeker and decide whether to contact the jobseeker and thereby incur a cost in purchasing the contact information of the jobseeker.

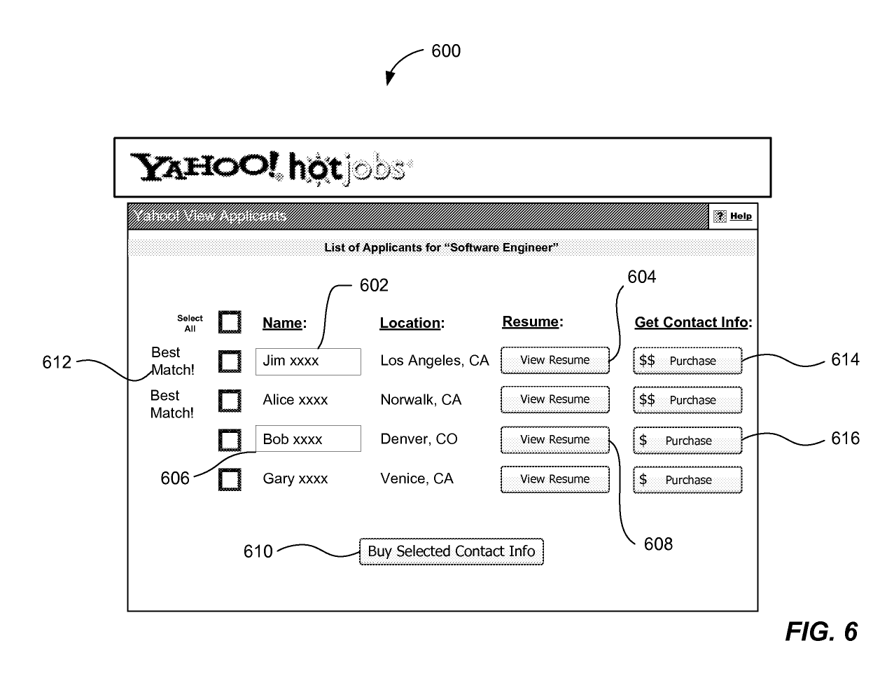

FIG. 6 depicts an exemplary user interface for listing jobseekers that have applied for a job listing posted by the recruiter according to one embodiment. Once the jobseeker or multiple jobseekers apply for a job listing, the recruiter can be provided with a list of jobseekers who have applied for the job listing of the recruiter. In one embodiment, the recruiter can receive an email alerting the recruiter that a jobseeker has applied for the job associated with a job posting of the recruiter. In another embodiment, the job listing service provider 120 permits the recruiter to visit a web page that lists all the job postings of the recruiter as well as associated listings of applicants for each job posting.

User interface 600 shows an exemplary list of applicants for a job for Software Engineer that has been listed or posted by the recruiter. A listing 602 corresponds to an applicant jobseeker that has associated qualifications determined to be a good match for the Software Engineer job posted by the recruiter. A match indicator 612 can be included next to the listing 602 in order to indicate to the recruiter that the applicant corresponding to listing 602 has the best matching qualifications in relation to the posted job. As such, the recruiter can select a button 604, view the resume and parse through the qualifications of the jobseeker corresponding to listing 602. If the recruiter decides that the jobseeker corresponding to listing 602 is a jobseeker that the recruiter would like to interview, or at least contact, the recruiter can select button 613 in order to obtain the contact information of the jobseeker associated with listing 602. Because the jobseeker's qualifications for listing 602 have been determined by the relevance module 107 to match the job requisites, the contact information of the jobseeker is more valuable to the recruiter and therefore can be provided to the recruiter at a higher price. In general, recruiters receive a large number of resumes or job applications—some of which are not relevant or qualified. Therefore, recruiters are generally relegated to the tedious task of reviewing multiple resumes or applications to only find a few that match the requisites of a job opening posted by the recruiter. By providing an indication that a resume might be best fitting or matching, the recruiter can save a lot of time, and therefore, the costs of obtaining the contact information for a jobseeker that has been predetermined to be a good match are well justified.

Likewise, a listing 606 for a second jobseeker that has applied for the position or job listing can also be provided in conjunction with the option of viewing the resume of the jobseeker. The recruiter can view the resume of the jobseeker corresponding to listing 606 by selecting the button 608. If the recruiter decides to contact the jobseeker associated with listing 606, the recruiter can select button 616 in order to obtain contact information of the jobseeker. However, the jobseeker qualifications may not match the requisites of the job listing, and therefore the contact information of the jobseeker can be provided at a lower price to the recruiter.

In another embodiment, a button 610 can be provided in order to allow a recruiter to obtain multiple contact information of jobseekers. As previously mentioned, a recruiter can be provided with the option of paying for an individual price for each jobseeker contact information received. Alternatively, the recruiter can select to obtain contact information in bulk. That is, the recruiter can for example select to obtain contact information for ten applicants and receive a discount from the job listing service provider 120 of the total price of the contact information.

### Resume Search

Contact information can be provided to a recruiter based on a search that was entered by a recruiter. A recruiter can utilize the recruiter computing device 122 to submit a search for jobseekers that have associated metadata preferences or qualifications that meet the search criteria of the recruiter. Upon receiving the search from the recruiter, the search engine 108 can locate one or more jobseekers' profiles from the job seeker profile database 116 and list the jobseekers' profiles and associated resumes for inspection by a recruiter. Once the jobseeker's contact information is displayed, the recruiter can select to view and/or obtain the contact information of a selected jobseeker that a recruiter is interested in.

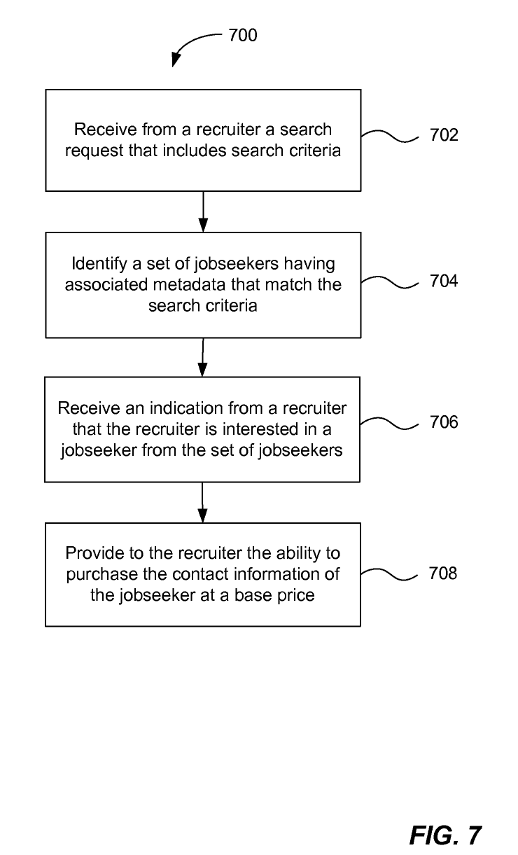

FIG. 7 depicts a flow diagram of a processor for permitting a recruiter to search for jobseekers and obtain contact information for one or more jobseekers according to one embodiment. At process block 702, a search request that includes search criteria is received from a recruiter. The search criteria can include jobseeker qualifications such as certifications, a specific degree, experience and/or any other keywords that the recruiter finds relevant to include as part of the search criteria. Process 700 continues at process block 704.

At process block 704, a set of jobseekers having metadata that match the search criteria entered by the recruiter is identified. The set of jobseekers can be identified by the search engine 108 by searching the job seeker profile database 116 in order to locate jobseekers that meet the search criteria. Process 700 continues at process block 706.

At process block 706, an indication from a recruiter is received indicating that the recruiter is interested in a jobseeker from the list of jobseekers. The indication of interest can be, for example, a selection to receive the contact information of the jobseeker. Process 700 continues at process block 708.

At process block 708, the recruiter is provided with the ability to purchase the contact information of the jobseeker at a base price. Thus, once an indication from the recruiter that the recruiter is interested in the jobseekers received, the contact information can for example be provided to the recruiter at a predetermined price.

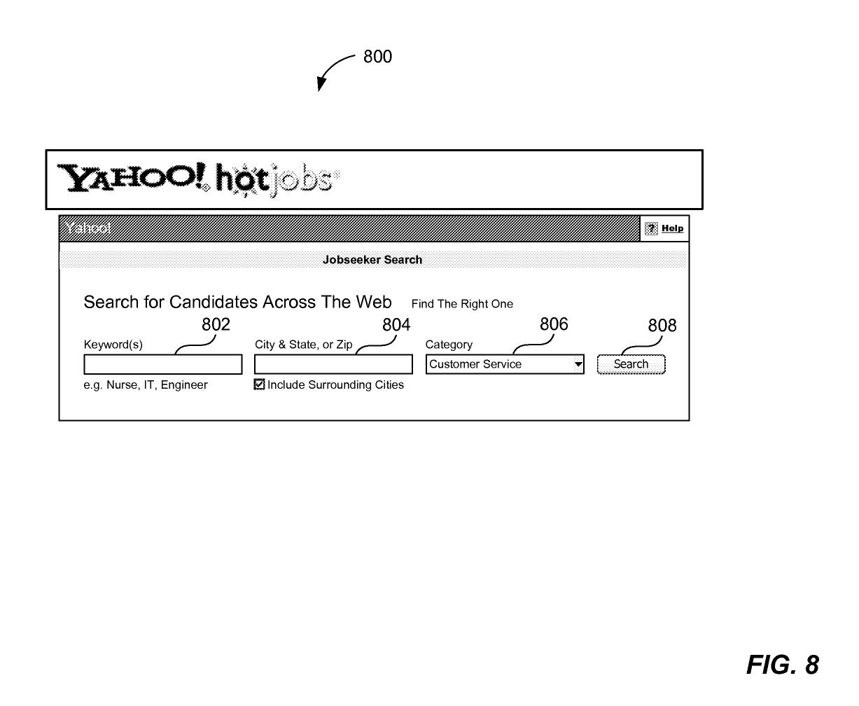

FIG. 8 depicts an exemplary user interface for permitting a recruiter to enter and submit a search for jobseekers according to one embodiment. User interface 800 includes text fields 802 and 804 that a recruiter can utilize to enter search criteria. For example, in text field 802 a recruiter can enter keywords that can be utilized to locate jobseekers that have profile metadata associated with such keywords. In addition, the recruiter can also enter city, state or zip code as well as selecting whether surrounding cities can be included at text field 804.

Furthermore, user interface 800 can also include a drop down menu 806 that would permit a recruiter to enter a category of the jobseeker. The category of the jobseeker can be a category in which the jobseeker has indicated to possess skills, expertise, certification, etc. Examples of categories can include customer service, technology, legal, entertainment, sales, etc. In addition, a search button 808 can also be provided in order to execute a search.

As previously discussed, the search engine 108 can utilize searched words entered by the recruiter to retrieve jobseekers from the jobseekers profiles database 116. Thus, keywords entered into text field 802, as well as the location entered in 804, and job industries or categories located in 806, can be utilized as part of the search of the jobseekers profile database 116. If for example the recruiter enters the keywords “software” and “engineer” in text field 802, the job listings provided would include any job listing that has as part of the title or metadata associated with the job listing the words engineer and software.

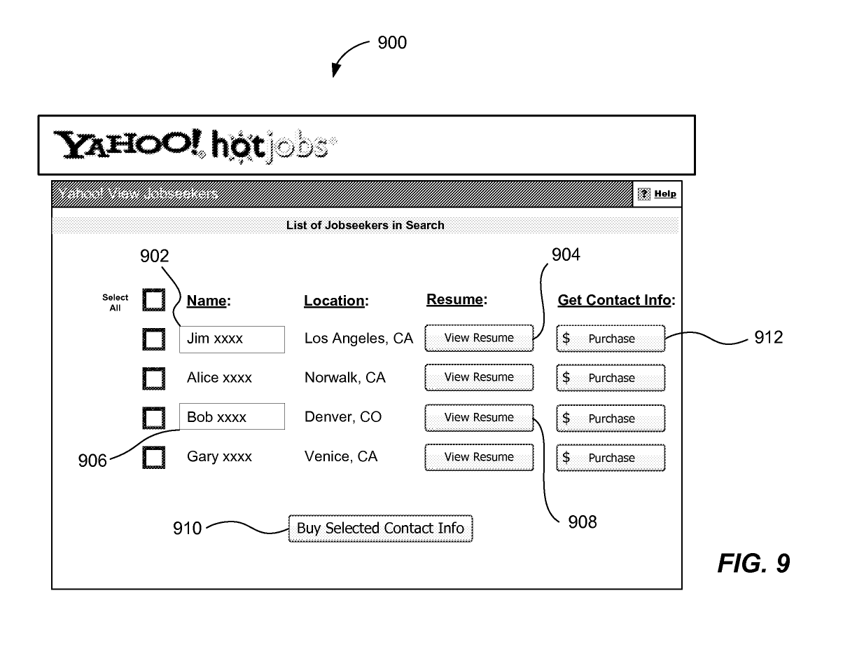

FIG. 9 depicts an exemplary user interface for listing jobseekers that result from a search for jobseekers by a recruiter according to one embodiment. User interface 900 includes a listing 902 that corresponds to a jobseeker. In one example, the search engine 108 determines that metadata associated with the jobseeker profile and qualifications and/or preferences of the jobseeker matched the search criteria entered by the recruiter. For instance, the jobseeker corresponding to listing 902 is displayed in the list of jobseekers because one or more qualifications of the jobseeker match the search criteria.

As such, the recruiter is presented with the option of viewing the resume of the jobseeker corresponding to the listing 902 and inspecting the resume of the jobseeker. Once the recruiter determines that the recruiter is interested in contacting the jobseeker, the recruiter can select button 912 in order to receive the contact information corresponding to the jobseeker of listing 902. The recruiter can select to receive the contact information by pressing or clicking on the button 912. The accounting module 912 can then calculate the amount to be charged to the recruiter for obtaining the contact information of the jobseeker corresponding to listing 902.

In another embodiment, a button 910 can be provided to select multiple jobseekers and associated contact information. For example, the recruiter can check the one or more checkboxes associated with jobseekers and list of jobseekers and select to receive the contact information of the selected jobseekers in bulk. This option would allow a recruiter to receive contact information for multiple jobseekers at a discounted price. In one example, the job listing service provider 120 can provide a price structure that a recruiter can select. For example, a recruiter can select to obtain contact information of ten jobseekers at the price of one dollar per unit. In another example, the recruiter can select to obtain contact information of twenty jobseekers at the price of eighty cents per unit.

In another example, one or more price structures can be provided by the job listing service provider. For example, there can be a platinum service in which the recruiter pays a membership fee of $1,000 and the recruiter can obtain the contact information of any jobseeker for no additional cost. In another example, the recruiter can select a different price structure such as a gold service wherein the recruiter pays a membership fee of $400 and pays one dollar every time the recruiter requests contact information of a jobseeker. In another example, in a silver price structure the recruiter would have to pay a membership fee of $200 and download each resume or contact information for a five dollar fee. In yet another example, another service such as a bronze service can allow a recruiter to pay no membership fee but pay a ten dollar fee for each download or contact information.

### Matching

As mentioned earlier, the relevance module 107 can be configured to automatically determine a set of jobseekers that can be recommended to a recruiter for interviewing. The relevance module 107 utilizes the metadata associated with each job listing in the job listings database 114 associated with the recruiter in searches for job seekers having jobseeker profiles that can be good candidates to fill the position corresponding to the job listings of the recruiter. As such, the recruiter can be presented with one or more jobseekers and associated resumes for inspection by the recruiter. Once the recruiter decides or selects one or more jobseekers, the recruiter can receive the contact information of each of the selected jobseekers at a price.

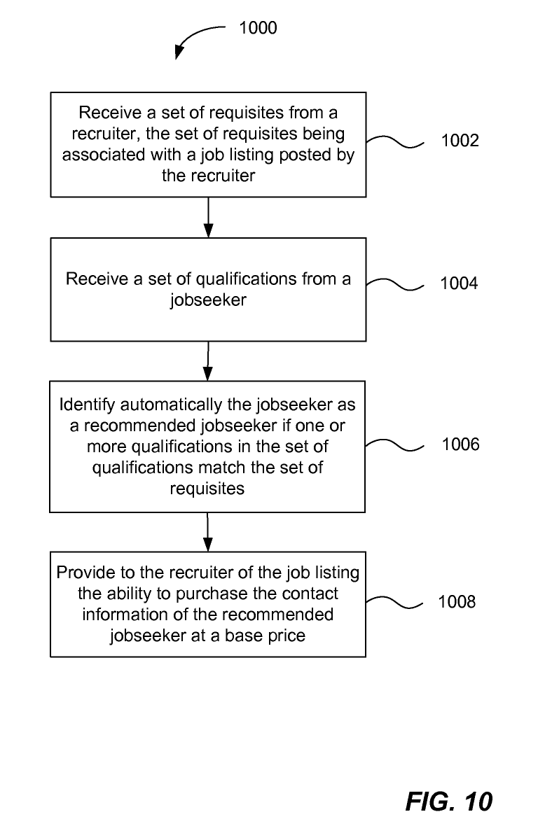

FIG. 10 depicts a flow diagram of a process for providing a recruiter with contact information of one or more recommended jobseekers according to one embodiment. At process block 1002, a set of requisites is received from a recruiter. The set of requisites can be associated with a job listing that has been posted by the recruiter. The set of requisites can for example be a specific certification, skill set, spoken language, job experience, education or any other requisite that a recruiter associates with a job listing. Process 1000 continues at process block 1004.

At process block 1004, a set of qualifications is received from a jobseeker. The set of qualifications can include degrees and certificates received by the jobseeker, previous employment experiences, skill sets, etc. The qualifications received from the jobseeker can be stored in the jobseeker profile in the jobseekers profile database 116. Process 1000 continues at process block 1006.

At process block 1006, the jobseeker that submitted the set of qualifications can be deemed a recommended job seeker if the jobseeker is identified as having one or more qualifications that match the set of requisites of the job listing. Once the identification of the matching is provided, the recruiter can be provided with a list of jobseekers. The list of jobseekers can be inspected by the recruiter and further allow the recruiter to view the resume of each of the jobseekers in the list of jobseekers. Process 1000 continues at process block 1008.

At process block 1008, the recruiter of the job listing is provided with the ability to purchase contact information of the recommended jobseeker at a base price. Thus, the recruiter can be provided with the resume for inspection without being provided with the contact information. The recruiter can pay a price for receiving the contact information in order to be able to contact the jobseeker for a potential interview. A recruiter is provided with the incentive that the jobseeker is a good match to the recruiter because many of the keywords in the set of requisites in the job listing matched many of the qualifications of the jobseeker.

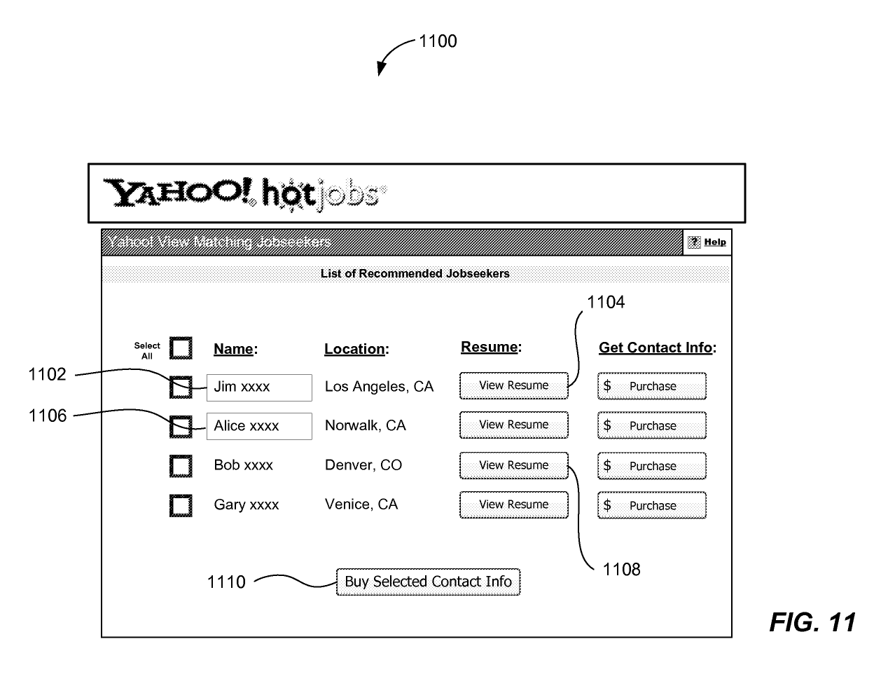

FIG. 11 depicts an exemplary user interface that lists recommended jobseekers according to one embodiment. User interface 1100 includes a listing 1102 that corresponds to a recommended jobseeker. The jobseeker corresponding to listing 1102 is displayed in the list of jobseekers as a result of the relevance module 107 determining that the recommended jobseeker is a good match for jobs posted by the recruiter. Thus, in one embodiment, the recruiter can be presented with a list of recommended jobseekers for one job posted by the recruiter. In another embodiment, the recruiter can be presented with a list of recommended jobseekers for multiple jobs posted by the recruiter.

As previously mentioned the relevance module 107 can determine whether metadata associated with the jobseeker profile (e.g., qualifications and/or preferences of the jobseeker) match requisites of one or more jobs posted by the recruiter.

Matching jobseekers can be presented to the recruiter and listed with access to view the resume of the matching jobseeker. As such, the recruiter is presented with the option of viewing the resume of one or more recommended jobseekers. For example, a jobseeker corresponding to the listing 1102 can be displayed along with the option to view and inspect the resume of the jobseeker. Once the recruiter determines that the recruiter is interested in contacting the jobseeker, the recruiter can select button 1112 in order to receive the contact information corresponding to the jobseeker of listing 1102. As such, the recruiter can select to receive the contact information by pressing or clicking on the button 1112. The accounting module 1112 can calculate the amount to be charged to the recruiter for obtaining the contact information of the jobseeker corresponding to listing 1102.

In another embodiment, a button 1110 can be provided to select multiple jobseekers and associated contact information. For example, the recruiter can check one or more checkboxes associated with jobseekers to list the jobseekers. Once the checkboxes are selected, the recruiter can request to receive the contact information of the selected jobseekers in bulk. This option would allow a recruiter to receive contact information for multiple jobseekers at a discounted price. As discussed previously, various pricing configurations and structures can be established in order to offer recruiters the contact information of jobseekers.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware, software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features, functions and interfaces, and those variations and modifications that may be made to the hardware, software or firmware components described herein as would be understood by those skilled in the art now and hereafter.

1. A method of providing jobseeker contact information to a recruiter, comprising:
receiving from a recruiter a search request that includes search criteria;
identifying a set of jobseekers having associated metadata that match the search criteria;
receiving an indication from a recruiter that the recruiter is interested in a jobseeker from the set of jobseekers; and
providing to the recruiter the ability to purchase contact information of the jobseeker for a base price.

2. The method of claim 1, further comprising permitting the recruiter to view a resume of the jobseeker before purchasing the contact information of the jobseeker.

3. The method of claim 1, further comprising:
determining if qualifications of the jobseeker are relevant to the job; and
charging the recruiter an additional fee if the qualifications of the jobseeker are determined to be more relevant.

4. The method of claim 1, wherein contact information of a plurality of jobseekers can be provided to the recruiter in bulk such that the recruiter can receive a discounted price when purchasing contact information for multiple jobseekers.

5. The method of claim 1, wherein the recruiter pays no subscription fee in addition to the base fee.

6. The method of claim 1, further comprising charging the recruiter a reduced subscription fee in addition to the base fee.

7. A system to provide jobseeker contact information to a recruiter, comprising:
a search engine that searches a jobseeker database to identify a set of jobseekers having associated metadata that match a search criteria received from the recruiter, the search criteria received as part of a jobseeker search request;
a user interface module that communicates with a recruiter computing device and with a jobseeker computing device, the user interface module configured to receive the jobseeker search request, the user interface module further configured to receive an indication from the recruiter that the recruiter is interested in a jobseeker from the set of jobseekers, the user interface module further configured to permit the recruiter to purchase contact information of the jobseeker; and
an accounting module that charges a base price to the recruiter if the recruiter purchases the contact information of the jobseeker.

8. The system of claim 7, wherein the user interface module further permits the recruiter to view a resume of the jobseeker before the recruiter purchases the contact information of the jobseeker.

9. The system of claim 7, further comprising a relevance module that determines whether qualifications of the jobseeker are relevant to the job, the accounting module further configured to charge the recruiter an additional fee if the qualifications of the jobseeker are determined to be more relevant.

10. The system of claim 7, wherein the accounting module is configured to charge a discounted price when buying contact information for multiple jobseekers.

11. The system of claim 7, wherein the accounting module is configured not to charge the recruiter a subscription fee in addition to the base fee.

12. The system of claim 7, wherein the accounting module is configured to charge the recruiter a reduced subscription fee in addition to the base fee.
